(19) United States
(12) Patent Application Publication
(10) Pub. No.: US 2026/0342195 A1
(43) Pub. Date: Oct. 29, 2026

(54) VOICE COIL MOTOR AND CAMERA DEVICE

(71) Applicant: Luxshare Intelligent Manufacture Technology (Changshu) Co., Ltd., Changshu City (CN)

(72) Inventors: JenCheng Sung, Changshu City (CN); SinHong Lin, Changshu City (CN); ChiYing Lee, Changshu City (CN); HaoYun Lee, Changshu City (CN); WenYen Huang, Changshu City (CN)

(73) Assignee: Luxshare Intelligent Manufacture Technology (Changshu) Co., Ltd., Changshu City (CN)

(21) Appl. No.: 19/374,344

(22) Filed: Oct. 30, 2025

(30) Foreign Application Priority Data
Apr. 25, 2025 (CN) 202510533759.4

(51) Int. Cl. H02K 41/035; G03B 13/34

(52) U.S. Cl. CPC H02K 41/0354; G03B 13/34

(57) ABSTRACT

A voice coil motor includes a mounting base, a casing, and an adhesive body. A middle area of the mounting base is hollowed out to form an accommodation space. The mounting base has a plurality of outer side walls. A lower edge of the outer side walls protrudes outward to form a protruding portion. The casing is sleeved on the outer side walls of the mounting base. A lower edge of the casing and the protruding portion mutually match. A side of the protruding portion facing upward is configured as a serrated structure. The adhesive body is located between the casing and the mounting base.

### CLAIM OF PRIORITY AND CROSS-REFERENCE TO RELATED APPLICATION(S)

This application claims the benefit of Chinese Patent Application No. 202510533759.4, filed on April 25, 2025, which is incorporated herein by reference in its entirety.

### BACKGROUND OF THE DISCLOSURE

### FIELD OF THE DISCLOSURE

The present disclosure relates to the field of camera device structures, and particularly to a voice coil motor and a camera device.

### DESCRIPTION OF THE RELATED ART

Currently, when assembling the voice coil motor of a camera device, the bonding between the mounting base and the casing is not secure enough, and glue is prone to overflow into the mounting base, leading to product defects.

### BRIEF DESCRIPTION OF THE DISCLOSURE

In view of this, an object of the present disclosure is to provide a voice coil motor and a camera device, which prevent glue from overflowing into the mounting base and increase the surface area for gluing by the cooperation of the mounting base and the casing.

In a first aspect, the present disclosure provides a voice coil motor. The voice coil motor includes: a mounting base, a middle area of the mounting base is hollowed out to form an accommodation space, the mounting base has a plurality of outer side walls, a lower edge of each outer side walls protrudes outward to form a protruding portion, a side of the protruding portion facing upward is configured as a serrated structure; a casing, the casing is sleeved on the outer side walls of the mounting base, a lower edge of the casing and the protruding portion mutually match; and an adhesive body, the adhesive body is located between the casing and the mounting base.

In a second aspect, the present disclosure further provides a camera device. The camera device includes: the voice coil motor according to the first aspect.

Embodiments of the present disclosure provide a voice coil motor and a camera device. The voice coil motor includes a mounting base, a casing, and an adhesive body. A middle area of the mounting base is hollowed out to form an accommodation space. The mounting base has a plurality of outer side walls. A lower edge of the outer side walls protrudes outward to form a protruding portion. The casing is sleeved on the outer side walls of the mounting base. A lower edge of the casing and the protruding portion mutually match. A side of the protruding portion facing upward is configured as a serrated structure. The adhesive body is located between the casing and the mounting base.

### BRIEF DESCRIPTION OF THE DRAWINGS

Through the following description of the embodiments of the present disclosure with reference to the accompanying drawings, the above and other objects, features, and advantages of the present disclosure will become more apparent. In the drawings:

FIG. 1 is a structural schematic diagram of a mounting base according to an embodiment of the present disclosure;

FIG. 2 is a partially enlarged schematic diagram of a first glue groove according to an embodiment of the present disclosure;

FIG. 3 is a structural schematic diagram of the mounting base from another perspective according to an embodiment of the present disclosure;

FIG. 4 is a partially enlarged schematic diagram of a second glue groove according to an embodiment of the present disclosure;

FIG. 5 is a partially enlarged schematic diagram of a third glue groove according to an embodiment of the present disclosure;

FIG. 6 is a structural schematic diagram of a voice coil motor according to an embodiment of the present disclosure;

FIG. 7 is an exploded view of the voice coil motor according to an embodiment of the present disclosure;

FIG. 8 is a structural schematic diagram of a camera device according to an embodiment of the present disclosure.

### DETAILED DESCRIPTION OF EMBODIMENTS OF THE DISCLOSURE

The present application is described based on embodiments, but the present application is not limited to these embodiments. In the following detailed description of the present application, some specific details are described in detail. Those skilled in the art can fully understand the present application without the description of these details. In order to avoid obscuring the essence of the present application, known methods, procedures, flows, components, and circuits are not described in detail.

Furthermore, it should be understood by those of ordinary skill in the art that the drawings provided herein are for illustrative purposes, and the drawings are not necessarily drawn to scale.

Unless otherwise clearly specified and defined, terms such as "mount", "connect", "link", "fix" should be understood broadly. For example, it can be a fixed connection, a detachable connection, or integrated into one piece; it can be a mechanical connection, an electrical connection; it can be a direct connection, an indirect connection through an intermediary, or internal communication between two elements or the interaction relationship between two elements, unless otherwise clearly defined. Those of ordinary skill in the art can understand the specific meanings of the above terms in the present application according to specific situations.

For ease of description, spatial relative terms such as "inner", "outer", "under", "below", "lower portion", "above", "upper portion", etc., are used herein to describe the relationship between one element or feature illustrated in the figures and another element or feature. It will be understood that the spatial relative terms are intended to encompass different orientations of the device in use or operation in addition to the orientation depicted in the figures. For example, if the device in the figures is turned over, elements described as being "below" or "beneath" other elements or features would then be oriented "above" the other elements or features. Thus, the exemplary term "below" can encompass both above and below orientations. The device may be otherwise oriented (rotated 90 degrees or at other orientations), and the spatial relative descriptors used herein should be interpreted accordingly.

Unless the context clearly requires otherwise, throughout the description and the claims, the words "comprise", "comprising", and the like are to be construed in an inclusive sense as opposed to an exclusive or exhaustive sense; that is to say, in the sense of "including, but not limited to".

In the description of the present application, it is to be understood that the terms "first", "second", etc., are used for descriptive purposes only and cannot be understood as indicating or implying relative importance. Furthermore, in the description of the present application, unless otherwise stated, "a plurality of" means two or more.

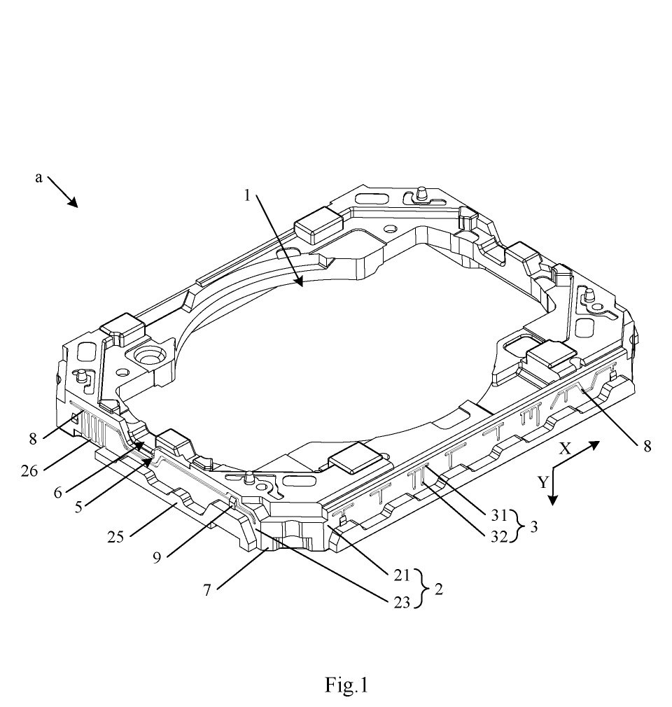

FIG. 1 is a structural schematic diagram of a mounting base according to an embodiment of the present disclosure. As shown in FIG. 1, the mounting base a has a plurality of outer side walls 2, and a middle area of the mounting base a is hollowed out to form an accommodation space 1. It should be noted that the mounting base a is used in a voice coil motor of a camera device, and a lens of the camera device is placed in the accommodation space 1. Further, the outer side walls 2 include a first outer side wall 21. The first outer side wall 21 is provided with a plurality of first glue grooves 3. The plurality of first glue grooves 3 are arranged at intervals along a first direction X. Further, each first glue groove 3 includes a first groove body 31 and at least one second groove body 32. The first groove body 31 is arranged along the first direction X. The second groove body 32 is arranged along a second direction Y. The second groove body 32 is connected to the first groove body 31. It should be noted that the first direction X and the second direction Y are two different directions on the first outer side wall 21. Optionally, a direction in which the outer side walls 2 extends horizontally is the first direction X, that is, the first direction X is the horizontal direction, the second direction Y is the vertical direction, and the second direction Y is arranged orthogonally to the first direction X.

It should be noted that the segmented first glue grooves 3 may conveniently adapt to the shape structure of the first outer side wall 21, and also help to selectively arrange the first glue grooves 3 at positions where the glue overflow problem is severe. Further, by providing the second groove body 32 in a different direction based on the first groove body 31, the first glue groove 3 helps to improve the ability to prevent glue overflow. It should be further noted that the sizes of the first groove body 31 and the second groove body 32 may be adjusted according to the shape structure of the first outer side wall 21 and the actual glue overflow situation. Further, an end of the first glue groove 3 is configured as an arc shape to improve the anti-overflow ability. On the other hand, the number of the second groove bodies 32 may be set according to the shape structure of the first outer side wall 21 and the actual glue overflow situation. For example, each first glue groove 3 may be provided with one, two, three, or more second groove bodies 32. Thus, by providing the first glue grooves 3, the mounting base a may prevent glue from overflowing into the accommodation space 1, while also increasing the surface area for glue adhesion, helping to avoid product defects.

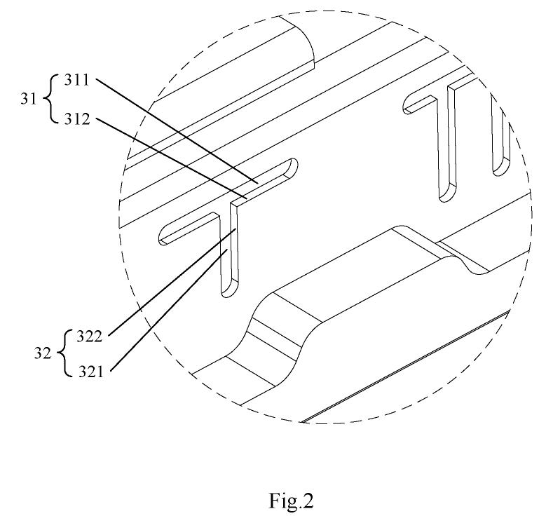

FIG. 2 is a partially enlarged schematic diagram of a first glue groove according to an embodiment of the present disclosure. As shown in FIG. 2, in one embodiment, the first groove body 31 includes a first groove bottom 311 and first groove walls 312 located on two sides of the first groove bottom 311. The first groove bottom 311 extends along the first direction X. Further, the second groove body 32 includes a second groove bottom 321 and second groove walls 322 located on two sides of the second groove bottom 321. The second groove bottom 321 extends along the second direction Y. Further, the first groove bottom 311 is connected to the second groove bottom 321, and a part of one of the first groove walls 312 is disconnected to connect with the second groove wall 322. In this embodiment, the first groove bottom 311 and the first groove walls 312 form a U-shaped groove structure, and the second groove bottom 321 and the second groove walls 322 form a U-shaped groove structure. It should be noted that the first glue groove 3 in this embodiment is configured as a U-shaped groove structure, which is convenient for processing and molding, and also helps prevent glue overflow. Optionally, the first glue groove 3 may also be configured as a V-shaped groove structure or other structures.

As shown in FIG. 2, in one embodiment, the first groove bottom 311 and the first groove walls 312 are respectively configured as planar structures, and the second groove bottom 321 and the second groove walls 322 are respectively configured as planar structures. It should be noted that the cross-sections of the first groove body 31 and the second groove body 32 in this embodiment are both rectangular, which is convenient for processing and molding and also helps prevent glue overflow. Optionally, the first groove bottom 311 and/or the first groove walls 312 may also be configured as curved surface structures, and the second groove bottom 321 and/or the second groove walls 322 may also be configured as curved surface structures.

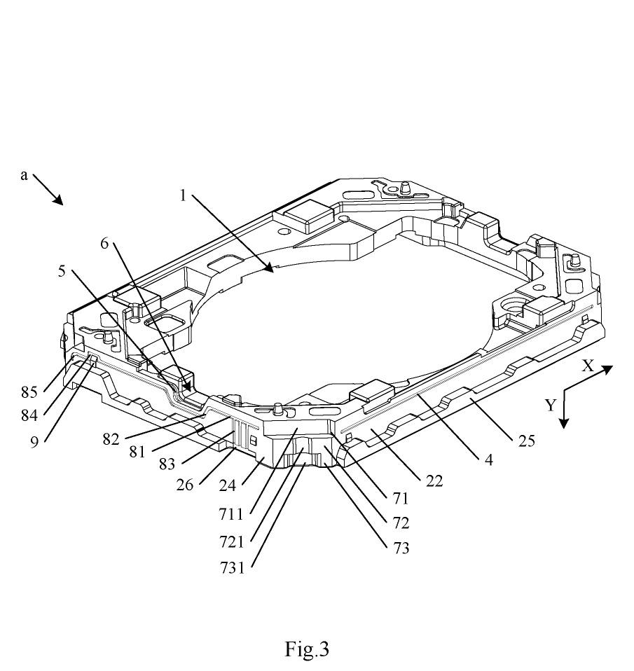

FIG. 3 is a structural schematic diagram of the mounting base from another perspective according to an embodiment of the present disclosure. As shown in FIG. 3, in one embodiment, the outer side walls 2 further include a second outer side wall 22. Further, the second outer side wall 22 is provided with a second glue groove 4 extending continuously along the first direction X. It should be noted that the continuously extending second glue groove 4 helps guide the flow of glue within the groove and may accommodate more glue, while also helping to estimate the required amount of glue to prevent over-application. Thus, by providing the second glue groove 4, the mounting base a may prevent glue from overflowing into the accommodation space 1, while also increasing the surface area for glue adhesion, helping to avoid product defects.

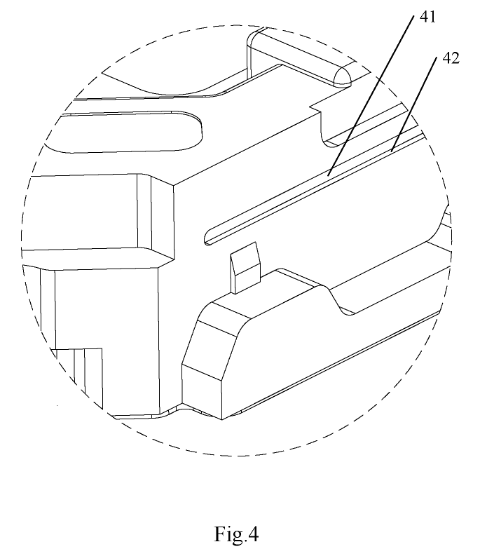

FIG. 4 is a partially enlarged schematic diagram of a second glue groove according to an embodiment of the present disclosure. As shown in FIG. 4, in one embodiment, the second glue groove 4 includes a third groove bottom 41 extending continuously along the first direction X and third groove walls 42 located on two sides of the third groove bottom 41. Further, the third groove bottom 41 and the third groove walls 42 form a U-shaped groove structure. It should be noted that the second glue groove 4 in this embodiment is configured as a U-shaped groove structure, which is convenient for processing and molding, and also helps prevent glue overflow. Optionally, the second glue groove 4 may also be configured as a V-shaped groove structure or other structures.

As shown in FIG. 4, in one embodiment, the third groove bottom 41 and the third groove walls 42 are respectively configured as planar structures. It should be noted that the cross-section of the second glue groove 4 in this embodiment is configured as a rectangle, which is convenient for processing and molding and also helps prevent glue overflow. Optionally, the third groove bottom 41 and/or the third groove walls 42 may also be configured as curved surface structures.

Referring to FIG. 1 and FIG. 3, in one embodiment, the first outer side wall 21 and the second outer side wall 22 are arranged opposite to each other. Thus, the positions of the first glue grooves 3 and the second glue groove 4 may be selected to adapt to the shape structure of the mounting base a, so that they may cooperate with each other to prevent glue from overflowing into the accommodation space 1, thereby preventing product defects.

Referring to FIG. 1 and FIG. 3, in one embodiment, the outer side walls 2 further include a third outer side wall 23 and a fourth outer side wall 24. Further, an upper edge of the third outer side wall 23 and/or the fourth outer side wall 24 is recessed to form a third glue groove 5. That is, the third glue groove 5 is configured as a step structure. It should be noted that the third glue groove 5 provided at the edge may cooperate with other glue grooves to achieve anti-overflow, specifically by allowing glue to flow to the third glue groove 5 after passing through other glue grooves. Therefore, the third glue groove 5 may be selectively provided at positions where the glue overflow problem is severe. Optionally, the third glue groove 5 may also be provided on the first outer side wall 21 and/or the second outer side wall 22 to cooperate with the first glue grooves 3 and/or the second glue groove 4 to prevent glue overflow.

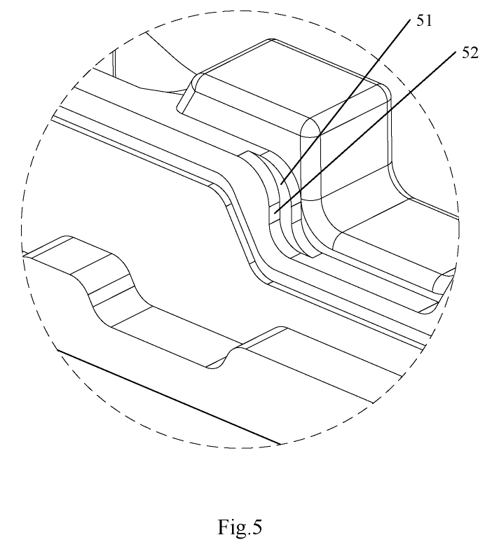

FIG. 5 is a partially enlarged schematic diagram of a third glue groove according to an embodiment of the present disclosure. As shown in FIG. 5, in one embodiment, the third glue groove 5 includes a fourth groove bottom 51 and a fourth groove wall 52. Further, the fourth groove bottom 51 and the fourth groove wall 52 form an L-shaped groove structure. It should be noted that the third glue groove 5 in this embodiment is configured as an L-shaped groove structure, which is convenient for processing and molding, and also helps prevent glue overflow. Optionally, the third glue groove 5 may also be configured as a V-shaped groove structure or other structures.

As shown in FIG. 5, in one embodiment, the fourth groove bottom 51 is configured as a planar structure, and the fourth groove wall 52 is configured as a curved surface structure. It should be noted that the specific structure of the third glue groove 5 may match the shape structure of the mounting base a, while considering processing efficiency and anti-overflow effect. Optionally, the fourth groove bottom 51 may also be configured as a curved surface structure, and the fourth groove wall 52 may also be configured as a planar structure.

Referring to FIG. 1 and FIG. 3, in one embodiment, the third outer side wall 23 and the fourth outer side wall 24 are arranged opposite to each other. It should be noted that the positions of the first glue grooves 3, the second glue groove 4, and the third glue groove 5 may be selected for reasonable distribution on the first outer side wall 21, the second outer side wall 22, the third outer side wall 23, and the fourth outer side wall 24 according to the specific structure of the mounting base a and the actual glue overflow situation.

Referring to FIG. 1 and FIG. 3, in one embodiment, a side of the mounting base a facing upward is recessed to form at least one notch 6, and the third glue groove 5 is provided at the notch 6. It is easy to understand that the position of the notch 6 is prone to glue overflow, and providing the third glue groove 5 at the notch 6 provides protection at this weak point.

Referring to FIG. 1 and FIG. 3, in one embodiment, a lower edge of each outer side wall 2 protrudes outward to form a protruding portion 25. It should be noted that the protruding portion 25 may play a certain limiting role during the assembly of the mounting base a. In addition, the protruding portion 25 may also function to prevent glue from flowing downward.

Referring to FIG. 1 and FIG. 3, in one embodiment, a side of the protruding portion 25 facing upward is configured as a serrated structure. It is easy to understand that the serrated structure helps guide the flow direction of excess glue, while the protruding structure may prevent the glue from continuing to flow downward. Thus, the protruding portion 25 may improve the anti-overflow capability of the mounting base a on the basis of different glue grooves.

Referring to FIG. 1 and FIG. 3, in one embodiment, the mounting base a has a plurality of chamfers 7. It should be noted that the chamfers 7 may improve the assembly performance of the mounting base a, and also provide more space to accommodate glue when the mounting base a is assembled with the casing, thereby achieving glue overflow prevention and improving the adhesive effect of the glue, helping to improve product yield.

Referring to FIG. 1 and FIG. 3, in one embodiment, each chamfer 7 includes a first part 71, a second part 72, and a third part 73. Further, the first part 71 is provided with a first recess 711, the second part 72 is provided with a second recess 721, and the third part 73 is provided with a third recess 731. It should be noted that the first recess 711, the second recess 721, and the third recess 731 may enhance the anti-overflow effect of the chamfers 7, because the glue-accommodating structure formed by the chamfers 7, namely the first part 71, the second part 72, and the third part 73, not only has an anti-overflow effect but also increases the surface area for glue adhesion, increasing the strength of fixation with the glue.

Referring to FIG. 1 and FIG. 3, in one embodiment, a depth of the first recess 711 is greater than a depth of the third recess 731, and the depth of the third recess 731 is greater than a depth of the second recess 721. Further, a groove bottom size of the first recess 711 is greater than a groove bottom size of the third recess 731, and the groove bottom size of the third recess 731 is greater than a groove bottom size of the second recess 721. Optionally, the groove bottoms of the first recess 711, the second recess 721, and the third recess 731 may be configured as planar structures or curved surface structures, the groove walls of the first recess 711, the second recess 721, and the third recess 731 may be configured as planar structures or curved surface structures, and the groove walls of the first recess 711, the second recess 721, and the third recess 731 may be inclined at a certain angle relative to the groove bottom. It should be noted that setting the structural dimensions of the first recess 711, the second recess 721, and the third recess 731 may enhance the anti-overflow effect of the chamfers 7.

Referring to FIG. 1 and FIG. 3, in one embodiment, the outer side wall 2 is provided with a fourth glue groove 8. Further, the fourth glue groove 8 includes a third groove body 81 arranged along the first direction X, a fourth groove body 82 bent relative to the third groove body 81, and at least one fifth groove body 83 arranged along the second direction Y. The fourth groove body 82 is connected to the third groove body 81, and the fifth groove body 83 is connected to the third groove body 81. It should be noted that by providing the bent fourth groove body 82, the fourth glue groove 8 may conveniently adapt to the shape structure of the outer side wall 2. By providing the fifth groove body 83 in a different direction based on the third groove body 81, the ability to prevent glue overflow may be improved. At the same time, the bending angle and the number of bends of the fourth groove body 82 may be set according to the shape structure of the outer side wall 2 and the actual glue overflow situation. Optionally, the fourth groove body 82 may be provided on the first outer side wall 21, the second outer side wall 22, the third outer side wall 23, and/or the fourth outer side wall 24 as needed. It should be further noted that the sizes of the third groove body 81, the fourth groove body 82, and the fifth groove body 83 may be adjusted according to the shape structure of the outer side wall 2 and the actual glue overflow situation. On the other hand, the number of the fifth groove bodies 83 may be set according to the shape structure of the outer side wall 2 and the actual glue overflow situation. For example, each fourth glue groove 8 may be provided with one, two, three, or more fifth groove bodies 83. Thus, by providing the fourth glue groove 8, the mounting base a may prevent glue from overflowing into the accommodation space 1, while also increasing the surface area for glue adhesion, helping to avoid product defects.

Referring to FIG. 1 and FIG. 3, in one embodiment, the fourth glue groove 8 further includes a sixth groove body 84. Specifically, the sixth groove body 84 is connected to the third groove body 81, and a width of the sixth groove body 84 is greater than a width of the third groove body 81. Further, an abutting portion 9 is protrudingly formed on the outer side wall 2, and the abutting portion 9 extends into the sixth groove body 84. It should be noted that the abutting portion 9 is used to abut against the casing to ensure firm assembly of the mounting base a. On this basis, providing the sixth groove body 84 at the position of the abutting portion 9 in the fourth glue groove 8 may cooperate with the abutting portion 9 to further prevent glue overflow.

Referring to FIG. 1 and FIG. 3, in one embodiment, the fourth glue groove 8 further includes a seventh groove body 85. Specifically, the seventh groove body 85 is connected to the third groove body 81, and the seventh groove body 85 is curved relative to the third groove body 81. It should be noted that the seventh groove body 85 is located at an end of the fourth glue groove 8 and curves downward, helping to improve the anti-overflow capability of the fourth glue groove 8.

In one embodiment, the vertical cross-sections of the third groove body 81, the fourth groove body 82, the fifth groove body 83, the sixth groove body 84, and the seventh groove body 85 are rectangular, forming a U-shaped groove structure, which is convenient for processing and molding and helps prevent glue overflow. Optionally, various parts of the fourth glue groove 8 may also be configured as V-shaped groove structures or other structures.

Referring to FIG. 1 and FIG. 3, in one embodiment, a lower edge of the outer side wall 2 is provided with a leakage groove 26. Specifically, the leakage groove 26 is located below the fifth groove body 83 and is connected to the fifth groove body 83. It is easy to understand that the fifth groove body 83 cooperating with the leakage groove 26 may improve the anti-overflow capability of the fourth glue groove 8.

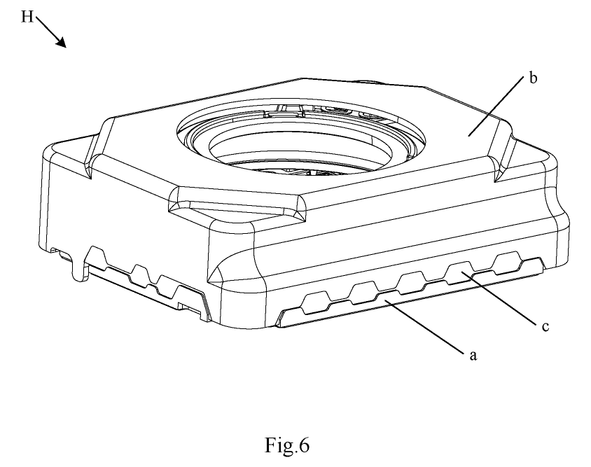

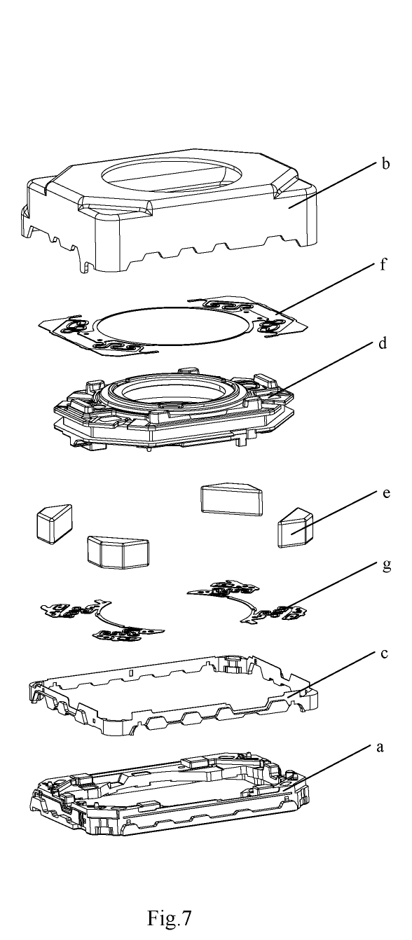

An embodiment of the present disclosure further provides a voice coil motor. FIG. 6 is a structural schematic diagram of a voice coil motor according to an embodiment of the present disclosure. FIG. 7 is an exploded view of the voice coil motor according to an embodiment of the present disclosure. Referring to FIG. 6 and FIG. 7, the voice coil motor H includes the mounting base a. It should be noted that the specific structure of the mounting base a is as described above and will not be repeated here. Thus, by providing the mounting base a with glue grooves, the voice coil motor H may prevent glue from overflowing into the accommodation space 1, while also increasing the surface area for glue adhesion, helping to avoid product defects.

Referring to FIG. 6 and FIG. 7, in one embodiment, the voice coil motor H further includes a casing b and an adhesive body c. Specifically, the casing b is sleeved on the outer side walls 2 of the mounting base a, and a lower edge of the casing b is configured as a serrated structure. Further, the adhesive body c is located between the casing b and the mounting base a. It is easy to understand that a part of the adhesive body c is located within the first glue grooves 3, the second glue groove 4, the third glue groove 5, and the fourth glue groove 8. It should be noted that the lower edge of the casing b matches the protruding portion 25, and the protruding portion 25 protrudes outward relative to the casing b by a certain distance, thereby ensuring that the adhesive body c is not applied downward.

As shown in FIG. 7, in one embodiment, the voice coil motor H further includes a carrier d, magnets e, an upper spring plate f, and a lower spring plate g. Specifically, a coil is sleeved around the periphery of the carrier d, a center of the carrier d is used for mounting a lens, there are four magnets e provided at the four corner positions of the carrier d, the upper spring plate f is provided above the carrier d and the magnets e and is connected to the casing b, and the lower spring plate g is provided below the carrier d and the magnets e and is located on the mounting base a. It is easy to understand that after the coil in the voice coil motor H is energized, the generated electromagnetic force may be used to drive the coil 11 to move axially, thereby driving the carrier d equipped with the lens to move, so that the lens achieves a focusing function. The upper spring plate f and the lower spring plate g may reset the carrier d after the coil is powered off.

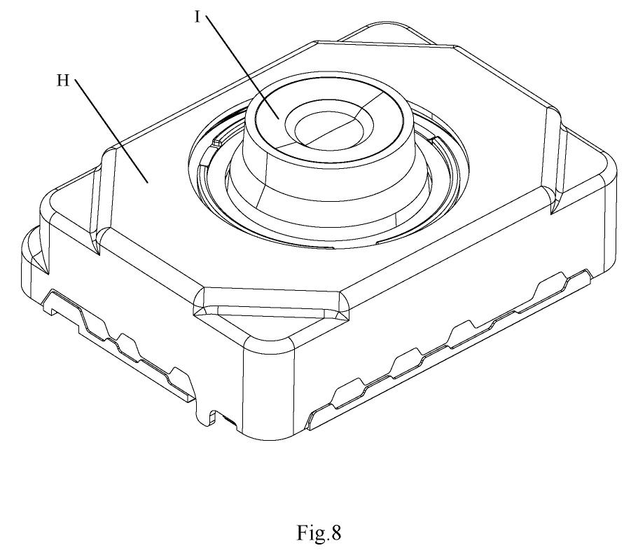

An embodiment of the present disclosure further provides a camera device. FIG. 8 is a structural schematic diagram of a camera device according to an embodiment of the present disclosure. As shown in FIG. 8, the camera device includes the voice coil motor H and a lens I. It should be noted that the specific structure of the voice coil motor H is as described above and will not be repeated here. Further, the lens I is mounted on the voice coil motor H and may achieve a focusing function under the action of the voice coil motor H. Among them, by providing the mounting base a with glue grooves, glue may be prevented from overflowing into the accommodation space 1, while also increasing the surface area for glue adhesion, helping to improve the quality of the camera device.

Embodiments of the present disclosure provide a voice coil motor and a camera device. The voice coil motor includes a mounting base, a casing, and an adhesive body. A middle area of the mounting base is hollowed out to form an accommodation space. The mounting base has a plurality of outer side walls. A lower edge of each outer side wall protrudes outward to form a protruding portion. The casing is sleeved on the outer side walls of the mounting base. A lower edge of the casing and the protruding portion mutually match. The adhesive body is located between the casing and the mounting base. Thus, the voice coil motor, through the cooperation of the mounting base and the casing, may prevent glue from overflowing into the accommodation space, while increasing the surface area available for gluing, helping to avoid product defects.

The above descriptions are only preferred embodiments of the present application and are not intended to limit the present application. For those skilled in the art, the present application may have various modifications and changes. Any modifications, equivalent replacements, improvements, etc., made within the spirit and principle of the present application shall be included within the protection scope of the present application.

We claim:

1. A voice coil motor, wherein the voice coil motor comprises:
a mounting base, a middle area of the mounting base is hollowed out to form an accommodation space, the mounting base has a plurality of outer side walls, a lower edge of each outer side walls protrudes outward to form a protruding portion;
a casing, the casing is sleeved on the outer side walls of the mounting base, a lower edge of the casing and the protruding portion mutually match, a side of the protruding portion facing upward is configured as a serrated structure; and
an adhesive body, the adhesive body is located between the casing and the mounting base.

2. The voice coil motor according to claim 1, wherein the lower edge of the casing is configured as a serrated structure.

3. The voice coil motor according to claim 1, wherein the outer side walls include a second outer side wall, a direction in which the outer side walls extend horizontally is a first direction, the second outer side wall is provided with a second glue groove extending continuously along the first direction.

4. The voice coil motor according to claim 3, wherein the second glue groove includes a third groove bottom extending continuously along the first direction and third groove walls located on two sides of the third groove bottom, the third groove bottom and the third groove walls form a U-shaped groove structure.

5. The voice coil motor according to claim 4, wherein the third groove bottom and the third groove walls are respectively configured as planar structures.

6. The voice coil motor according to claim 3, wherein a part of the adhesive body is located within the second glue groove.

7. The voice coil motor according to claim 1, wherein the outer side walls include a third outer side wall and a fourth outer side wall, an upper edge of the third outer side wall and/or the fourth outer side wall is recessed to form a third glue groove.

8. The voice coil motor according to claim 7, wherein a part of the adhesive body is located within the third glue groove.

9. The voice coil motor according to claim 7, wherein the third glue groove includes a fourth groove bottom and a fourth groove wall, the fourth groove bottom and the fourth groove wall form an L-shaped groove structure.

10. The voice coil motor according to claim 9, wherein the fourth groove bottom is configured as a planar structure, the fourth groove wall is configured as a curved surface structure.

11. The voice coil motor according to claim 7, wherein the third outer side wall and the fourth outer side wall are arranged opposite to each other.

12. The voice coil motor according to claim 7, wherein a side of the mounting base facing upward is recessed to form at least one notch, the third glue groove is provided at the notch.

13. The voice coil motor according to claim 1, wherein the mounting base has a plurality of chamfers.

14. The voice coil motor according to claim 13, wherein each chamfer includes a first part, a second part, and a third part, the first part is provided with a first recess, the second part is provided with a second recess, the third part is provided with a third recess.

15. The voice coil motor according to claim 14, wherein a depth of the first recess is greater than a depth of the third recess, the depth of the third recess is greater than a depth of the second recess, a groove bottom size of the first recess is greater than a groove bottom size of the third recess, the groove bottom size of the third recess is greater than a groove bottom size of the second recess.

16. The voice coil motor according to claim 1, wherein the voice coil motor further comprises:
a carrier, the carrier is located above the mounting base; and
four magnets, the magnets are provided at the four corner positions of the carrier.

17. The voice coil motor according to claim 16, wherein the voice coil motor further comprises:
an upper spring plate, the upper spring plate is provided above the carrier and the magnets and is connected to the casing; and
a lower spring plate, the lower spring plate is provided below the carrier and the magnets and is located on the mounting base.

18. A camera device, comprising:
a voice coil motor according to claim 1.

19. The camera device according to claim 18, further comprising:
a lens, the lens being mounted on the voice coil motor.
